(19) United States
(12) Patent Application Publication
(10) Pub. No.: US 2023/0278244 A1
(43) Pub. Date: Sep. 7, 2023

(54) ELECTRONIC HAIR CLIPPER WITH DIGITAL TAPER LEVER AND METHOD OF USE THEREOF

(71) Applicants: Kevin Thang Nguyen, San Diego, CA (US); Jeovany Calero, Providence, RI (US)

(72) Inventors: Kevin Thang Nguyen, San Diego, CA (US); Jeovany Calero, Providence, RI (US)

(21) Appl. No.: 18/097,465

(22) Filed: Jan. 16, 2023

Related U.S. Application Data
(60) Provisional application No. 63/315,536, filed on Mar. 2, 2022.

(51) Int. Cl. B26B 19/38; B26B 19/20

(52) U.S. Cl. CPC B26B 19/388; B26B 19/205; B26B 19/3853

(57) ABSTRACT

The present disclosure relates to a smart and novel electronic hair clipper with a digital taper lever. Particularly, the electronic hair clipper includes a housing, a pair of clipper blades disposed on a top portion of the housing, and a digital taper lever disposed along an upper side portion of the housing near the clipper blades for electronically controlling a taper lever height.

### RELATED APPLICATIONS

This application claims the benefit of priority of U.S. Provisional Application Ser. No. 63/315,536 filed Mar. 2, 2022, which is hereby incorporated by reference in its entirety.

### FIELD OF THE DISCLOSURE

The present disclosure relates to an electronic hair clipper with a digital taper lever. Particularly, the hair clipper includes an advanced digitally control mechanism which is configured to directly replace a mechanical taper lever of the hair clipper. The advanced digitally control mechanism has a unique arc shape pattern and orientation which is disposed on the same side of the mechanical taper lever, allowing a barber to adjust the taper lever height with their thumb while using a natural hair cutting motion.

### BACKGROUND

An electronic hair clipper is a specialized tool used to trim human head hair, having a sliding blade clipper with sharp teeth that moves back and forth for cutting hair which passes through the blade.

FIG. 1 illustrates a typical electric hair clipper 10 having a body with a handle portion 10-1, a pair of sharpened teeth-like blades 10-3 in close contact, one above the other, and the sides that slide sideways relative to each other, a taper lever 10-5 disposed along an upper portion of the clipper near the blades for manually adjusting the height (H) of the blades 10-3 by moving the taper lever 10-5 forward and backward, and an internal electronic components and mechanisms (not shown) that causes the blades to oscillate from side electrically. In operation, when one blade of the clipper swings sideways in relation to the other, it creates a scissor action that cuts the hair that is positioned between the comb’s teeth. Lowest possible friction between the blades must be achieved, which is done by selecting the right material and finish as well as applying lubricant frequently.

Most electric hair clippers generally use an electric motor to cause the blades to oscillate. The production of such clippers uses three different motor types: magnetic, rotary, and pivot. Direct current or alternating current electricity sources can power rotary styles. The magnetic forces that are produced by winding copper wire around steel are used in both magnetic and pivot style clippers. In order to generate the speed and torque necessary to move the clipper cutter across the combing blade, alternating current creates a cycle that attracts and relaxes a spring.

Considering technological advancements in the digital and electronics industry, the basic operation of electronic hair clippers have not changed in the overall shape, handling, and function over the last hundred years. Because the basic handling and operation of the electronic hair clippers remains unchanged over the last century, barbers and hair cutting professionals have been trained and instructed on such devices, developing their own hair cutting styles and methods thereon.

Therefore, it would be highly desirable to have a smart and ergonomically correct electronic hair clipper having advanced features that is intuitive and extremely easy-to-use by barbers and hair cutting professionals.

### SUMMARY

It is an advantage of the present disclosure to provide a smart and novel electronic hair clipper including a housing, a pair of clipper blades disposed on a top portion of the housing, and a digital taper lever disposed along an upper side portion of the housing near the pair of clipper blades for electronically controlling a taper lever height of the pair of clipper blades, where the digital taper lever includes a touch sensor having an arc shape pattern that has an inward curve along a portion of the arc shape pattern, where the inward curve of the arc shape pattern is oriented in an upward direction facing the pair of clipper blades, and where the taper lever height is adjusted by a swiping action that is controlled by a thumb of a user along the touch sensor.

It is another advantage of the present disclosure to provide a method of cutting hair with a smart and novel electronic hair clipper including a housing having a handle portion, a pair of clipper blades disposed on a top portion of the housing, and a digital taper lever disposed along an upper side portion of the housing near the pair of clipper blades for electronically controlling a taper lever height of the pair of clipper blades, where the digital taper lever includes a touch sensor having an arc shape pattern that has an inward curve along a portion of the arc shape pattern, and where the inward curve of the arc shape pattern is oriented in an upward direction facing the pair of clipper blades, the method including gripping the handle portion of the housing by a hand of a user, applying a thumb of the user over the digital taper lever, pressing the thumb firmly against the touch sensor making contact thereon, and swiping the thumb along the arc shape pattern of the touch sensor to increase or decrease a taper lever height setting of the digital taper lever.

These and other objects, features and advantages of the present disclosure will become more apparent in light of the following detailed description of preferred embodiments thereof, as illustrated in the accompanying drawings.

### BRIEF DESCRIPTION OF THE DRAWINGS

The present disclosure will be more clearly understood from the following detailed description of the preferred embodiments of the disclosure and from the attached drawings, in which:

FIG. 1 illustrates a typical electric hair clipper.

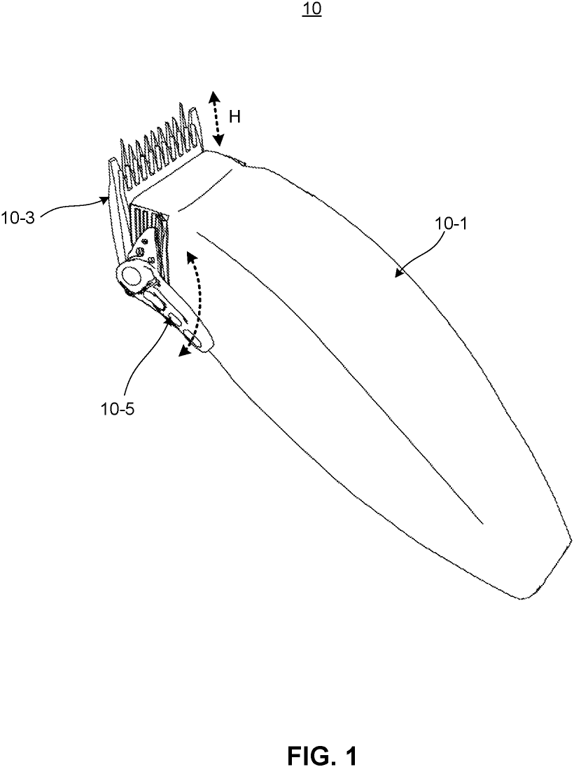

FIG. 2 illustrates a novel electronic hair clipper, in accordance to an embodiment.

FIGS. 3A - 3D illustrates a front, back, side, and perspective views, respectively, of the electronic hair clipper, in accordance to an embodiment.

FIG. 4 illustrates internal components of the electronic hair clipper, according to an embodiment.

FIGS. 5A - 5B illustrates expanded views of the actuator assembly and the haptic feedback component, respectively, in accordance to an embodiment.

FIGS. 6A - 6B illustrates expanded views of the digital taper lever disposed on a right side and a left side of the electronic hair clipper, respectively, in accordance to an embodiment.

FIGS. 7A - 7C illustrates adjustment settings on the touch sensor of the digital taper lever of the electronic hair clipper, in accordance to an embodiment.

FIGS. 8A - 8C illustrates alternative patterns of the digital taper lever and graphical indicators displayed in the touch sensor, in accordance to an embodiment.

FIG. 9 illustrates one or more smart water sensors disposed along a top portion of the electronic hair clipper near the clipper blades, according to an embodiment.

FIG. 10 illustrates additional activating sensors and switches for enabling the digital taper lever of the electronic hair clipper, in accordance to an embodiment.

FIG. 11 illustrates the LED/LCD screen of the electronic hair clipper, according to an embodiment.

FIG. 12 illustrates a system block diagram of the printed board circuit and clipper components/sensors, in accordance to an embodiment.

FIG. 13 illustrates a pseudocode related to operational and procedural steps of adjusting the lever height setting of the electronic hair clipper, in accordance to an embodiment.

FIG. 14 illustrates a swiping action on the touch sensor by a thumb of the user for adjusting the lever height on the digital taper lever of the electronic hair clipper, in accordance to an embodiment.

FIG. 15 illustrates a method of operating the digital taper lever of the electronic hair clipper, in accordance to an embodiment.

In the appended figures, one or more elements may have the same reference numeral in different figures indicating previously described.

### DETAILED DESCRIPTION

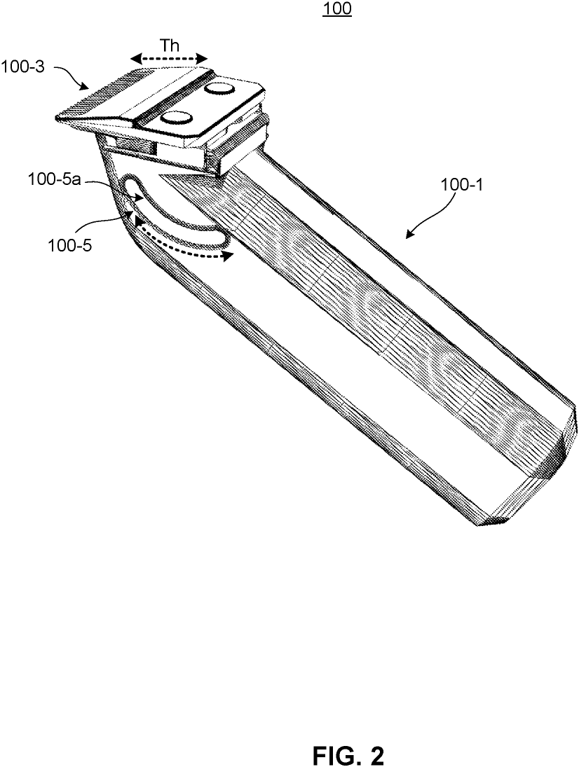

FIG. 2 illustrates a smart and novel electronic hair clipper 100 having a housing 100-1, a pair of sharpened teeth-like clipper blades 100-3 (stationary clipper blade and moving cutter blade) in close contact, a digital taper lever 100-5 disposed along an upper side portion of the clipper near the blades for electronically adjusting a taper lever height (Th) of the clipper blades 10-3 by moving the taper lever 10-5 forward and backward, according to an embodiment. The digital taper lever 100-5 is a lever-less clipper having no physical lever to manually control the blade height. Instead, the digital taper lever 100-5 includes a touch sensor 100-5a where adjustments to the height and cutting length of the bladesfrom shorter to longer or vice versa are performed by a swiping action by the thumb of a user along the touch sensor. In response to the swiping action along the touch sensor of the digital taper lever 100-5, a signal is transmitted to an internal electronic controller and circuit that electronically adjust the taper lever height via internal gears and actuator mechanisms.

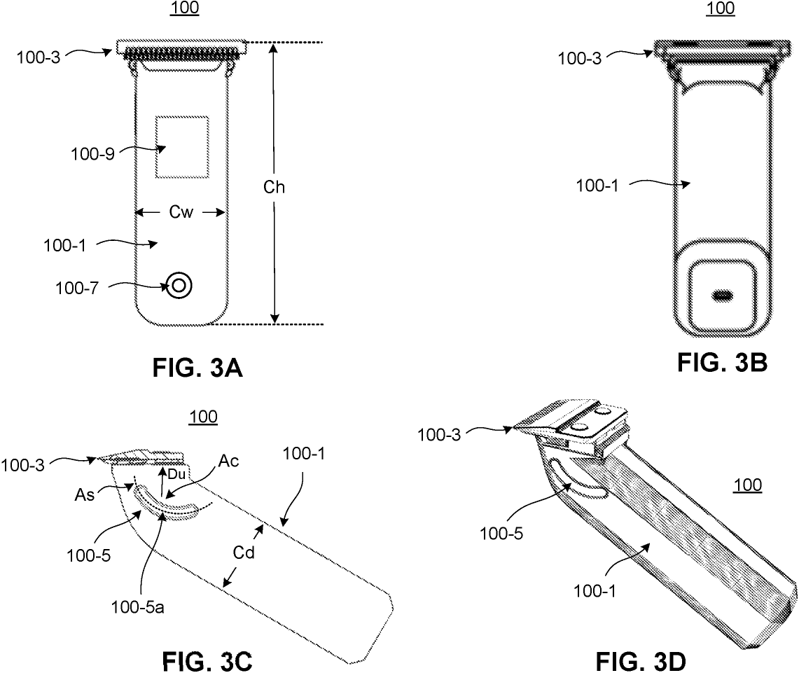

FIGS. 3A - 3D illustrates a front, back, side, and perspective views, respectively, of the electronic hair clipper 100, in accordance to an embodiment. The dimension of the electronic hair clipper 100 is approximately between 4-7 inches in height (Ch), 1-2 inches in width (Cw), and 1-2 inches in depth (Cd). It is to be understood that these dimensions are merely examples providing relative scale of the hair clipper 100 with respect to the user’s hand and is not intended to be limited by the above dimensions. In other words, the electronic hair clipper 100 may be manufactured to any size specification based on requirements by the end user. In addition, the electronic hair clipper 100 may include a main power ON/OFF button 100-7 and an LED/LCD screen 100-9 disposed along a front portion of the housing 100-1 as shown in FIG. 3A. Furthermore, the digital taper lever 100-5 is configured to have a novel arc shape pattern along a curved dotted line As where an inward curve (Ac) of the arc shape As is oriented in an upward direction (Du) facing the clipper blades 10-3 as shown in the side view of FIG. 3C. The arc shape pattern, position, and orientation are uniquely configured to provide smart and ergonomic features which mimic the natural motion and feel of making dynamic taper lever adjustments while using the electronic hair clipper 100. In one aspect, the electronic hair clipper 100 is commercially designed and generally intended for use by hair cutting professionals (e.g., barbers and hair shop owners) who are able to quickly take advantage of the smart and ergonomic features of the clipper without relearning new hair cutting techniques offered by the digital taper lever 100-5 as well as other electronic control features described later herein below. Advantageously, the smart and ergonomic features of the digital taper lever 100-5 in the electronic hair clipper 100 operate with a “natural” movement and feel accustomed by hair cutting professionals. In addition, long-term use of the digital taper lever 100-5 can prevent injury or strain to the user’s thumb since no pressure or tension are applied to the thumb when making adjustment to the digital taper lever 100-5 because it lacks physical mechanical parts, unlike physical taper levers.

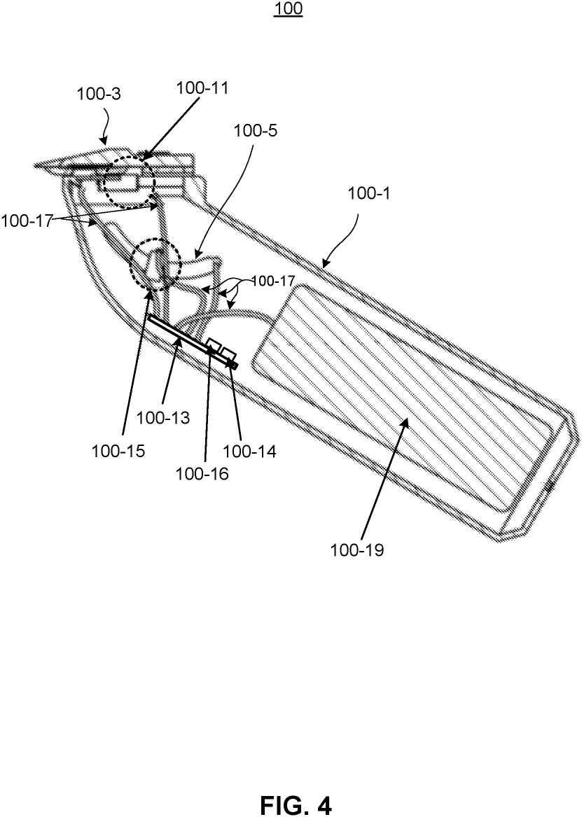

FIG. 4 illustrates internal components of the electronic hair clipper 100, according to an embodiment. These internal components may include an actuator assembly 100-11 disposed underneath the clipper blades 10-3 and coupled to the clipper blades 10-3 via mechanical driving members (e.g., mechanical gears, pistons, shaft, etc.), a haptic feedback component 100-15 disposed alongside the digital taper lever 100-5, and a printed board circuit (PCB) 100-13 coupled to the actuator assembly 100-11 and the haptic feedback component 100-15 via wiring members 100-17, a MEMS accelerometer 100-14 and a gyroscope sensor 100-16 both coupled to the PCB 100-13, and a battery 100-19 coupled to PCB 100-13 via wiring member 100-17 for providing power to the electronic hair clipper 100. In one instance, the accelerometer and/or gyroscope may provide additional functionality to the clipper by monitoring the angle of the clipper along different axes for precision and training purposes. In another instance, the printed board circuit 100-13 may also include a microprocessor, memory, an I/O system, and a system bus for executing predefined software and specific modes of operation of the electronic hair clipper 100.

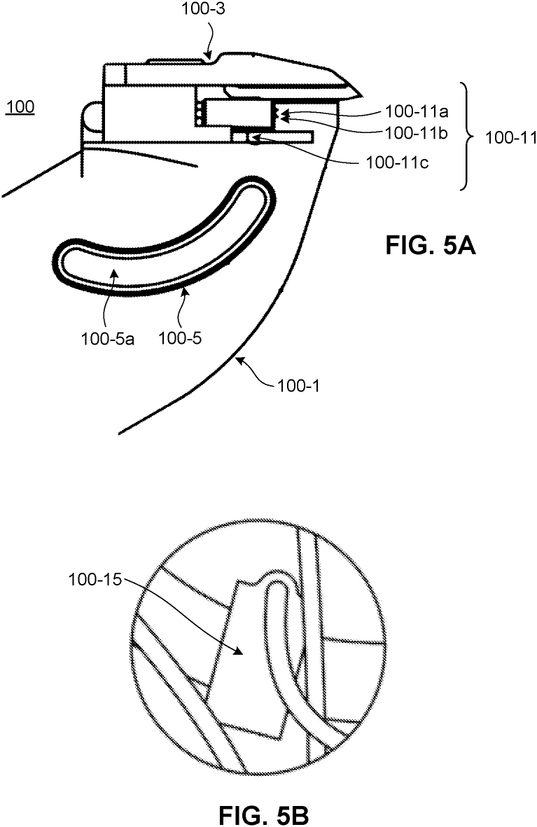

FIGS. 5A - 5B illustrates expanded views of the actuator assembly 100-11 and the haptic feedback component 100-15, respectively, in accordance to an embodiment. In FIG. 5A, the actuator assembly 100-11 may include one or more actuators 100-11a and actuator controller 100-11b that generates a stationary blade position motion and a blade position sensor 100-11c for communicating the exact position of the clipper blades 100-3 to the printed circuit board 100-13 in order to ensure that an adjustment setting on the touch sensor 100-5a and actual position of the blade are calibrated and match. In addition, the actuator assembly 100-11 may include calibration sensors or other measuring components to verify and check the accuracy and repeatability of the adjustment setting to that of the actual position of the blade. The haptic feedback component 100-15 shown in FIG. 5B may include vibrating element using haptic technology that provides a user a tactile experience by introducing forces, vibrations, pulses, or motions in response changes to the adjustment setting on the touch sensor 100-5a of the digital taper lever 100-5. In addition, the haptic feedback component 100-15 may have varying degrees of low to high intensity and tactile feedback depending on specific operations performed by the user (low taper setting, high taper setting, error feedback, etc.). In operation, when the touch sensor 100-5a of the digital taper lever 100-5 is adjusted by a swiping motion along the touch sensor 100-5a surface by the user, the haptic feedback component 100-15 provides the user a more tactile feeling via haptics pulse such as a click-like feeling based on the position of the blade. Electronics employ in haptic devices may include an eccentric rotating mass (ERM) actuator, which consists of an unbalanced weight fastened to a motor shaft. The actuator and the attached device wobble as a result of the uneven mass rotating as the shaft rotates. Additionally used to create vibrations, piezoelectric actuators provide even more precise motion than linear resonant actuators (LRAs), with less noise and on a smaller platform, but they also require higher voltages than ERMs and LRAs do.

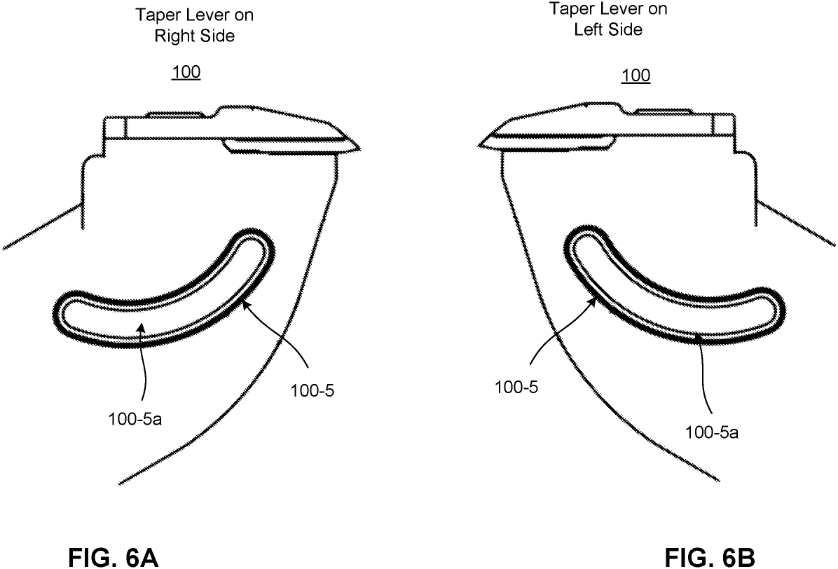

FIGS. 6A - 6B illustrates expanded views of the digital taper lever 100-5 disposed on a right side and a left side of the electronic hair clipper 100, respectively, according to an embodiment. Awkward and inadequate postures brought on by poorly built and improperly designed hair clippers can result in pain, exhaustion, and musculoskeletal problems. To prevent these negative impacts, ergonomic concepts are considered in the configuration of the electronic hair clipper 100 presented herein for specifically accommodating left and right-handed people. In one implementation, the digital taper lever 100-5 may be disposed on the left side, right side, or both sides of the electronic hair clipper 100, providing a comfortable, natural, and ergonomic feel for left and right-handed hair cutting professionals.

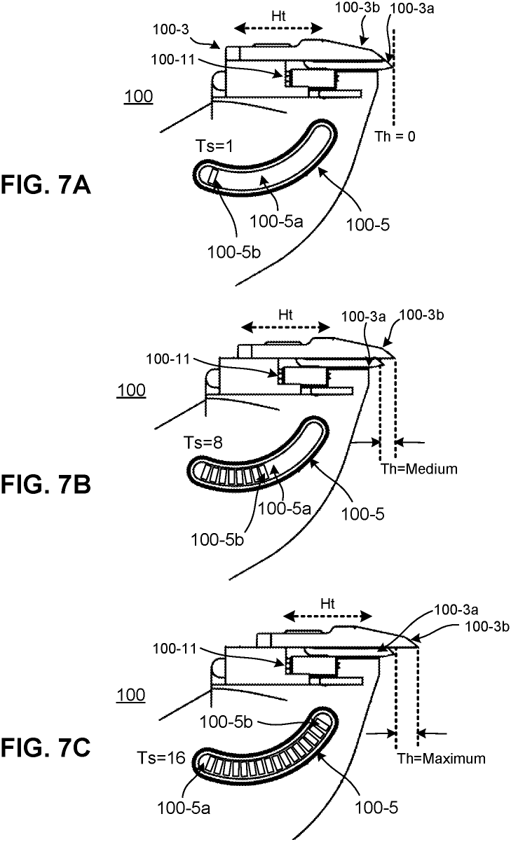

FIGS. 7A - 7C illustrates adjustment settings on the touch sensor 100-5a of the digital taper lever 100-5 of the electronic hair clipper 100, according to an embodiment. In one implementation, the touch sensor 100-5a of the digital taper lever 100-5 may include an electronic touchscreen panel capable of displaying graphical indicators 100-5b (e.g., bars, dots, lines, symbols, alpha-numeric characters, etc.) which represent a taper lever height setting (Ts) of the electronic hair clipper 100. The clipper blades 100-3 may include a stationary clipper blade 100-3a and a moving cutter blade 100-3b disposed above the stationary clipper blade 100-3a where a blade offset between the two blades (100-3a, 100-3b) represents a taper lever height (Th) which is controlled by the digital taper lever 100-5 via the touch sensor 100-5a. In operation, the stationary clipper blade 100-3a is moving and driven by the actuator assembly 100-11 along a horizontal position (Ht) above the stationary clipper blade 100-3a when the taper lever height (Th) is adjustedwhile the moving cutter blade 100-3b remains in its position vertically. The taper lever height (Th) may be adjusted between a zero taper lever height (Th=0) corresponding to the taper lever height setting of 1 bar (Ts=1) as shown in FIG. 7A to a maximum taper lever height (Th=maximum) corresponding to the taper lever height setting of 16 bars (Ts=16) as shown in FIG. 7C. In application, the taper lever height (Th) may be adjusted anywhere in between Th=0 to Th=maximum. For example, FIG. 7A illustrates a zero taper lever height (Th=0) with a zero blade offset between the sharp edge portion of the moving cutter blade 100-3b and the sharp edge portion of the stationary clipper blade 100-3a. At Th=0, the graphical indicator 100-5b may display a single bar where Ts=1, for example. FIG. 7B illustrates a medium taper lever height setting (Ts=8) with a medium blade offset between the sharp edge portion of the moving cutter blade 100-3b and the sharp edge portion of the stationary clipper blade 100-3a. At the medium taper lever height (Th= Medium), the graphical indicator 100-5b may display a medium number of bars, where Ts=8 out of 16 bars, for example. FIG. 7C illustrates a maximum taper lever height setting (Th=Maximum) with a maximum blade offset between the sharp edge portion of the moving cutter blade 100-3b and the sharp edge portion of the stationary clipper blade 100-3a. At the maximum taper lever height (Th= Maximum), the graphical indicator 100-5b may display a maximum number of bars, where Ts=16 out of 16 bars, for example. In an implementation, a user may adjust the taper lever height (Th) by swiping the touch sensor 100-5a along the arc using their thumb, thereby causing a signal to be transmitted to the printed circuit board 100-13 which controls the actuator assembly 100-11 to move and/or stop the moving cutter blade 100-3b at a desired taper lever height (Th). Examples of touchscreen panels include but are not limited to resistive touch panels, infrared touch panels, optical imaging touch panels, and projected capacitive touch panels. Examples of touch sensors without display panels include but are not limited to capacitive sensors, resistive sensors, piezoelectric, and triboelectric sensors. It is to be understood that the Th and Ts values described above are mere examples of possible values to the taper lever height and taper lever height setting and are not limited to these values. Other values of Th and Ts may be assigned depending on the application and requirements set forth by the manufacturer.

In another embodiment, the electronic hair clipper 100 may include predefined gap blade mode settings when operating the digital taper lever 100-5. The predefined gap mode setting is executed by the microprocessor via custom algorithms stored in memory having instructions for setting the gap of the blades at specific heights. This predefined setting may include a “zero-gap” blade mode or a “non-zero gap” blade mode. In context, the “zero-gap” mode is defined as the stationary blade is adjusted to be positioned as close as possible to the moving cutting blade. In effect, the stationary blade is aligned as precisely and safely as possible to the cutting blade allowing for the sharpest possible cut.

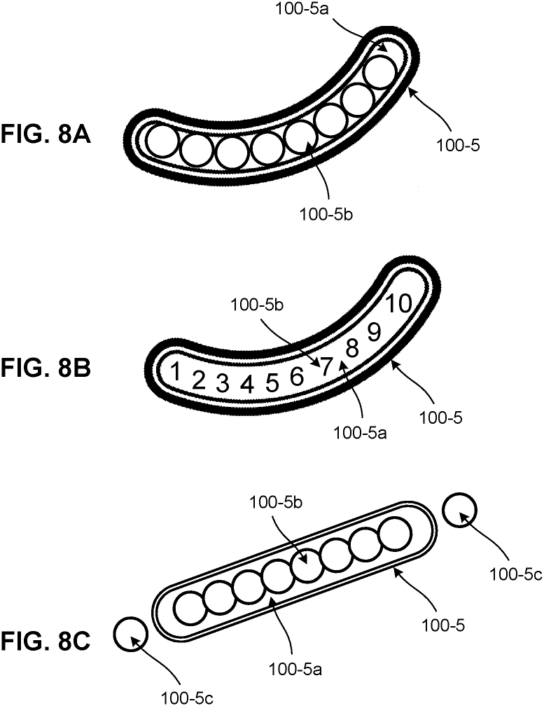

FIGS. 8A - 8C illustrates alternative patterns of the digital taper lever 100-5 and graphical indicators 100-5b displayed in the touch sensor 100-5a, according to an embodiment. In one aspect, the digital taper lever 100-5 may include the arc shape pattern having round graphical indicators 100-5b displayed in the touch sensor 100-5a as shown in FIG. 8A. In another aspect, the digital taper lever 100-5 may include the arc shape pattern having numerical graphical indicators 100-5b displayed in the touch sensor 100-5a as shown in FIG. 8B. In yet another aspect, the digital taper lever 100-5 may include a rounded rectangular pattern having circular graphical indicators 100-5b displayed in the touch sensor 100-5a as shown in FIG. 8C. In addition, the electronic hair clipper 100 may include one or more light indicators 100-5c which are proximate to the digital taper lever 100-5. The one or more light indicators 100-5c may be used as visual notification by enabling a green light when contact is made to the digital taper lever 100-5 or enabling a red light when an error occurs on the digital taper lever 100-5. Note, the patterns of the digital taper lever 100-5 and types of graphical indicators shown in FIGS. 8A-8C are mere examples of a few combinations of patterns and indicator markings but are not limited to such designs or combination of designs thereof. A preference of optimum patterns and designs associated with the digital taper lever 100-5 include those designs which provide smart and ergonomic features that give a “natural” movement and feel accustomed by hair cutting professionals when using the electronic hair clipper 100.

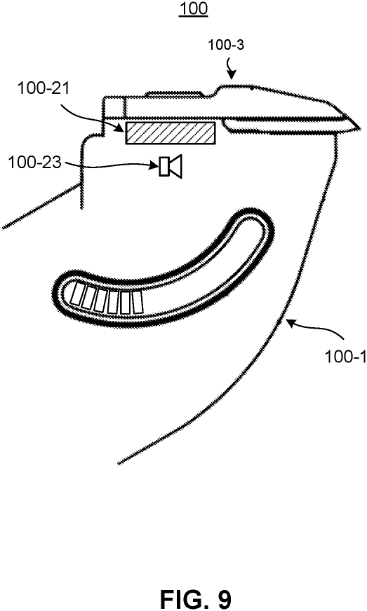

FIG. 9 illustrates one or more smart water sensors 100-21 disposed along a top portion of the electronic hair clipper 100 near the clipper blades 100-3, according to an embodiment. The smart water sensor 100-21 can identify water, which helps stop overly moist conditions or even excess water build-up that may enter the interior of the housing 100-1 and damage any electronics or battery therein of the electronic hair clipper 100. The smart water sensors 100-21 may be coupled to the printed circuit board 100-13 and transmit a signal to the PCB 100-13 when water is detected by one or more sensors 100-21, thereby triggering an visual alert on the LED/LCD screen 100-9 or an audio alert (e.g., beeping sound, melody, or voice-generated alert) on a speaker 100-23 disposed in a portion of the housing 100-1. The smart water sensors 100-21 may include two wired contacts that are configured to detect electrical conductivity of water by lower the resistance between the two contacts.

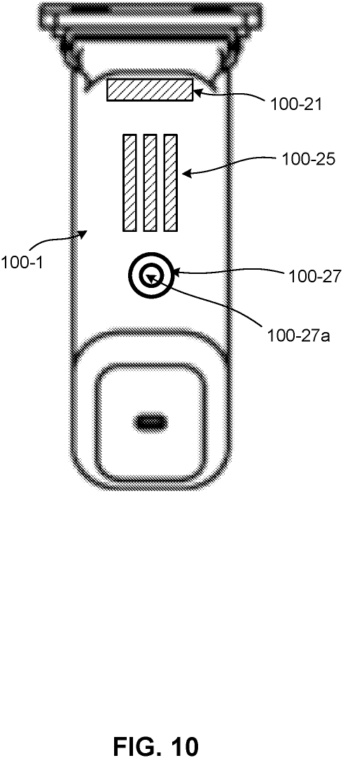

FIG. 10 illustrates additional activating sensors and switches for enabling the digital taper lever 100-5 of the electronic hair clipper 100, according to an embodiment. In one implementation, a trigger sensor 100-25 is disposed along a portion of the housing 100-1 for detecting the user’s hand when the user fully grips the electronic hair clipper 100. When the hand is detected by the sensor 100-25, a signal is then generated and transmitted to the PCB 100-13 which activates the digital taper lever 100-5, thereby allowing the user to adjust the settings on the touch sensor 100-5a of the digital taper lever 100-5 only when the electronic hair clipper 100 is fully gripped by the user’s hand. The trigger sensor 100-25 may include but is not limited to capacitive sensors, resistive sensors, piezoelectric, triboelectric sensors, and light sensors. In another implementation, a lock/unlock switch 100-27 is disposed along a portion of the housing 100-1 for disabling and enabling the digital taper lever 100-5 of the electronic hair clipper 100. The lock/unlock switch 100-27 may be coupled to the PCB 100-13 which activates adjustments on the touch sensor 100-5a of the digital taper lever 100-5 when the lock/unlock switch 100-27 is in an unlocked state and deactivates adjustments on the touch sensor 100-5a when the lock/unlock switch 100-27 is in a locked state, preventing the user from accidentally repositioning or adjusting the taper height when held in hand. In addition, the lock/unlock switch 100-27 may include a lock light indicator 100-27a to show whether the switch is locked or unlocked.

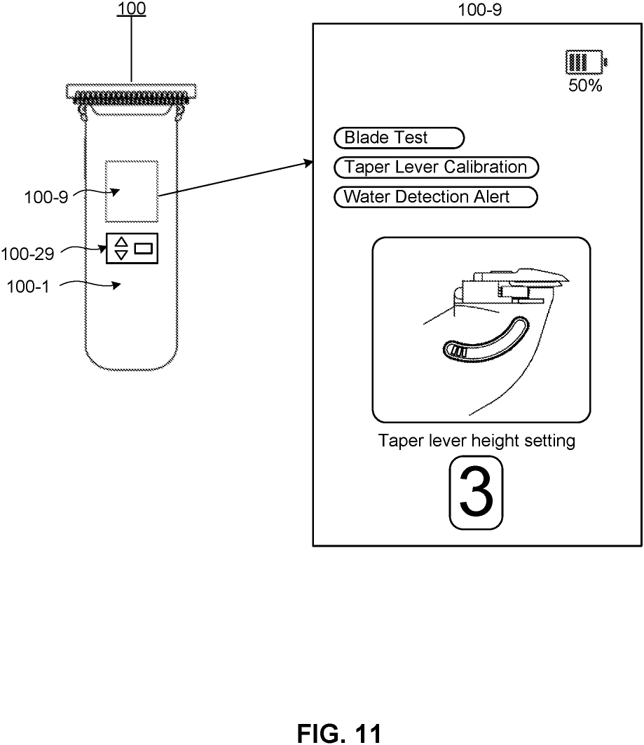

FIG. 11 illustrates the LED/LCD screen 100-9 of the electronic hair clipper 100, according to an embodiment. LED (light emitting diodes) and LCD (liquid crystal display) are liquid crystal displays having the basic technology with two layers of polarized glass through which the liquid crystals both block and pass light. LED, which stands for “light emitting diodes,” differs from LCD displays in that LCDs use fluorescent lights while LEDs use those light emitting diodes. In one aspect, the LED/LCD screen 100-9 generally disposed on the front side of the electronic hair clipper 100 and coupled to the PCB 100-13 for providing and displaying information to the user while operating the clipper 100. For example, the displayed information may include, but is not limited to, access to blade test information, access to a taper lever calibration, visual alerts of water detection by the smart water sensors, battery charge levels, graphical display of the taper lever height setting, and a numerical indicator of the taper lever height setting. In another implementation, a control pad 100-29 disposed adjacent to the LED/LCD screen 100-9 for selecting and setting options displayed thereon. In yet another implementation, LED/LCD screen 100-9 may be replaced by a touchscreen display for directly displaying, selecting, and setting options on the touchscreen itself.

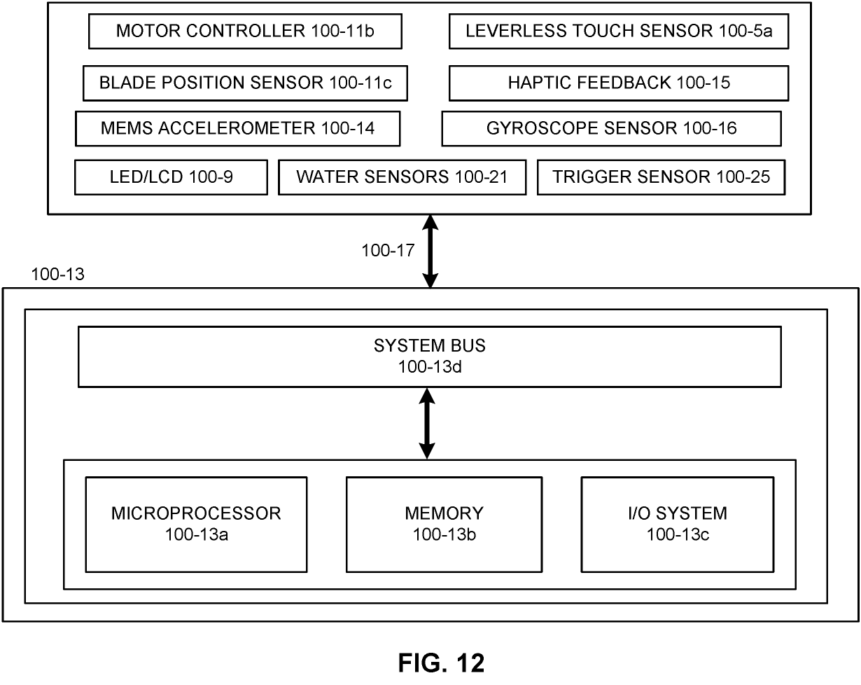

FIG. 12 illustrates a system block diagram of the printed board circuit 100-13 and clipper components/sensors, according to an embodiment. The printed board circuit 100-13 may include a microprocessor 100-13a, memory 100-13b, an I/O system 100-13c, and a system bus 100-13d. Data may be communicated between electrical components, controllers and sensors (i.e., actuator controller 100-11b, blade position sensors 100-11c, lever-less touch sensor 100-5a, LED/LCD 100-9, water sensors 100-21, MEMS accelerometer 100-14 and a gyroscope sensor 100-16, haptic feedback 100-15, and trigger sensor 100-25) and the microprocessor 100-13a via the system bus 100-13d and I/O system 100-13c which determines and executes processing instructions (e.g., firmware and source code) in order to adjust settings to the taper lever height setting, measure and calibrate clipper blades, display output, generate haptic feedback when adjustments are made to the lever height setting, trigger alerts, and operate other features of the electronic hair clipper 100.

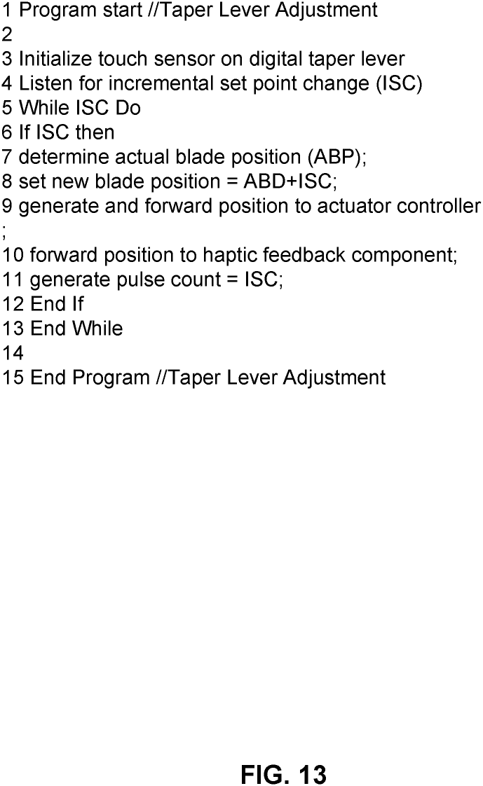

FIG. 13 illustrates a pseudocode related to adjusting the taper lever height setting of the electronic hair clipper 100, according to an embodiment. In an implementation, blade position sensors 100-11c disposed on the side of the clipper blades may communicate blade position data via wires 100-17 to the printed circuit board 100-13 which then stores this data into memory 100-13b. In addition, the printed circuit board 100-13 may also receive touch sensor data from the touch sensor 100-5a based on the user’s gestures thereon (including but not limited to; swipes, taps, presses, long holds, etc.). In response to the touch sensor data received by the PCB 100-13, the microprocessor 100-13a may then execute various functions, such as instructing the actuator assembly 100-11 to make a specific move on the electronic hair clipper 100, based on firmware/software algorithms that is stored in memory 100-13b. A myriad number of customized and proprietary software algorithms can be programmed and stored in memory, thereby providing the user an array of advantageous functions to support a variety of gesture inputs. Some of these gesture inputs and supporting functions include, but not are limited to a:
a) Swiping function to a location to have the actuator(s) move the clipper blade(s) to a specific position;
b) Double tap function to have the actuator(s) completely move the clipper blade(s) to the open position;
c) Triple tap function to have the actuator(s) completely move the clipper blade(s) to the closed position;
d) Long press function to give the clipper blade(s) more power.

In addition, the software algorithms may include instructions that will instruct the blade actuator assembly 100-11 to move the clipper blades to a specific location or any animation of key framed moves based on gesture inputs of the user on the touch sensor 100-5a, including pairing gesture inputs with different operations or moves. Moreover, the software algorithms may include instructions to control the intensity of the haptic feedback component 100-15 to simulate a more tactical feeling for the user in response to the type of gesture inputs received by the touch sensor 100-5a.

The pseudocode shown in FIG. 13 is an exemplary high level description of the steps in a software algorithm executed by the microprocessor 100-13a having structural conventions of a normal programming language, but is intended for human reading rather than computer reading. In this example, the software algorithm defines the basic code operation executed by the microprocessor 100-13a of the hair clipper 100 for adjusting the taper lever height setting via incremental changes to set points (ISC) made on the touch sensor 100-5a. In response to such changes, the algorithm further instructs the microprocessor 100-13a to determine the actual blade position from the blade position sensor and subsequently determine a new blade position which is then forwarded to the actuator controller 100-11b by which the taper lever height of the clipper blades may be adjusted.

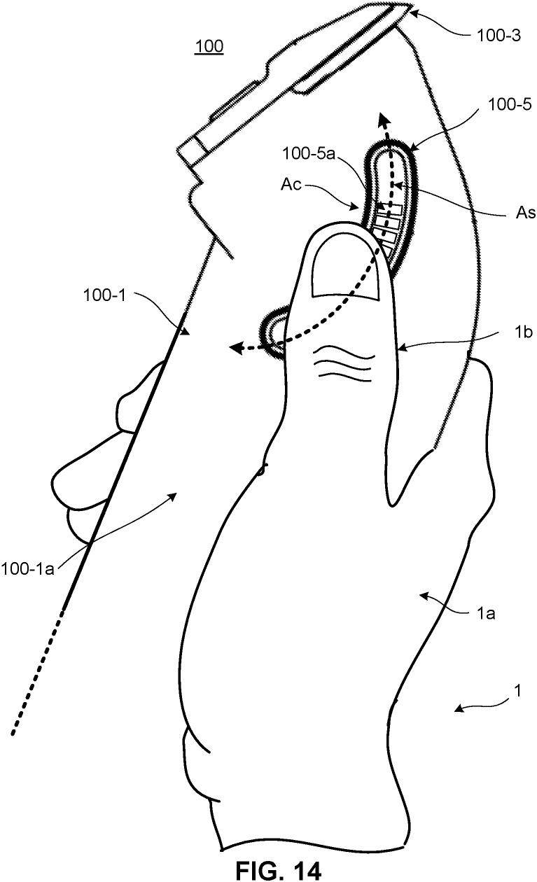

FIG. 14 illustrates a swiping action on the touch sensor 100-5a by a user 1 for adjusting the lever height on the digital taper lever 100-5 of the electronic hair clipper 100, according to an embodiment. As shown in FIG. 14A, an external lower portion of the housing 100-1 can act as a handle 100-1a by which the user 1 firmly grips and holds the electronic hair clipper 100 by the user’s hand 1a when cutting hair. While holding the electronic hair clipper 100 by the handle 100-1a, the user 1 can conveniently adjust the taper lever height (Th) by depressing the touch sensor 100-5a with their thumb 1b and then applying a swiping motion in an upward and downward direction along the arc shape (As) pattern of the digital taper lever 100-5. Advantageously, the touch sensor 100-5a can be programmed to only activate and adjust the taper lever height with the specific swiping motion (upward/downward motion) and programmed activate with lateral motions on the touch sensor 100-5a.

In practice, this swiping motion in a curve-like fashion mimics the same motion and feel of that of the mechanical taper lever 10-5 to which the hair cutting professional is already familiar and accustomed.

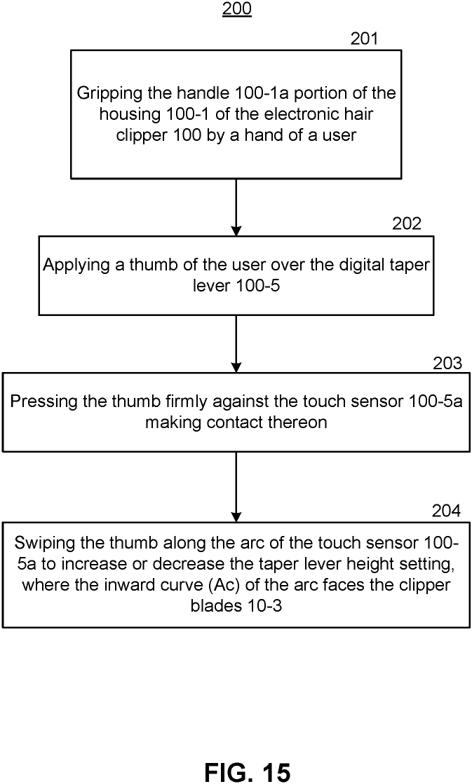

FIG. 15 illustrates a method of operating the digital taper lever 100-5 of the electronic hair clipper 100, according to an embodiment. A method for operating the digital taper lever 100-5 of the electronic hair clipper 100 may include the following steps:
1) Gripping the handle 100-1a of the housing 100-1 of the electronic hair clipper 100 by a hand 1a of a user 1; (Step 201)
2) Applying a thumb 1b of the user 1 over the digital taper lever 100-5; (Step 202)
3) Pressing the thumb 1b firmly against the touch sensor 100-5a making contact thereon; (Step 203)
4) Swiping the thumb 1b along an arc portion of the touch sensor 100-5a to increase or decrease the taper lever height setting of the digital taper lever 100-5, where the inward curve (Ac) of the arc faces the clipper blades 10-3; (Step 204)

In another embodiment, the method for operating the digital taper lever 100-5 of the electronic hair clipper 100 may include an additional step of:

1a) Enabling the touch screen 100-5a via the trigger sensor 100-25 of the electronic hair clipper 100 when the handle 100-1a of the housing 100-1 of the electronic hair clipper 100 is held by the hand of the user. This step may be performed at Step 201, prior to Step 202.

In one advantage, the novel electronic hair clipper 100 is designed to provide a natural use of the lever-less clipper in a professional hair cutting or barber environment where the natural motion of using the lever-less clipper mimics the mechanical taper lever of a conventional clipper. In another advantage, the digital taper lever 100-5 of the electronic hair clipper 100 is positioned on the same side of the mechanical taper lever which is controlled by the thumb of the user, conveniently and ergonomically allowing the hair cutting professional to use the clipper in a natural hair cutting fashion without the need of relearning the tool. In yet another advantage, the arc shape (As) design of the digital taper lever 100-5 provides a natural motion to move lever forward and backward. In addition, the touch sensor 100-5a of the digital taper lever 100-5 may include graphical display indicators, such as horizontal lines, indicating and matching the approximate taper lever height adjustment. Alternately, a visual image (picture) of the clipper blade showing the position of the lever can be displayed on the LEC/LCD screen on the housing of the electronic hair clipper 100. For professional, these advantageous features of the novel electronic hair clipper 100 allow them to utilize these new and advanced features thereon without having to relearn hair cutting skills or techniques.

As used in the specification and the appended claims, the singular forms “a”, “an”, and “the” included plural referents unless the context clearly dictates otherwise.

All patents, patent applications, and other references cited herein are incorporated by reference in their entireties.

It is noted that the foregoing disclosure has been provided merely for the purpose of explanation and is in no way to be construed as limiting of the present disclosure. Although the present disclosure has been shown and described with respect to several preferred embodiments thereof, various changes, omissions, and additions to the form and detail thereof, may be made therein, without departing from the spirit and scope of the disclosure. It is understood that the words which have been used herein are words of description and illustration, rather than words of limitation. Changes may be made, within the purview of the appended claims, as presently stated and as amended, without departing from the scope and spirit of the present disclosure in its aspects.

Other embodiments and modifications of the present disclosure may occur to those of ordinary skill in the art in view of these teachings. Accordingly, the disclosure is to be limited only by the following claims which include all other such embodiments and modifications when viewed in conjunction with the above specifications and accompanying drawings.

What is claimed is:

1. An electronic hair clipper comprising:
a housing;
a pair of clipper blades disposed on a top portion of the housing; and
a digital taper lever disposed along an upper side portion of the housing near the pair of clipper blades for electronically controlling a taper lever height of the pair of clipper blades, wherein the digital taper lever includes a touch sensor having an arc shape pattern that has an inward curve along a portion of the arc shape pattern, wherein the inward curve of the arc shape pattern is oriented in an upward direction facing the pair of clipper blades, and wherein the taper lever height is adjusted by a swiping action along the arc shape pattern of the touch sensor by a thumb of a user.

2. The electronic hair clipper of claim 1, further comprising internal components disposed inside an interior of the housing, wherein the internal components includes an actuator assembly disposed underneath the pair of clipper blades, a haptic feedback component disposed alongside the digital taper lever, a printed board circuit electrically coupled to the actuator assembly and the haptic feedback component via wiring members, and a battery coupled to printed board circuit via the wiring members for providing power to the electronic hair clipper.

3. The electronic hair clipper of claim 2, further comprising a main power button and an LED/LCD screen disposed along an external portion of the housing and electrically coupled to the printed board circuit via the wiring members.

4. The electronic hair clipper of claim 2, wherein the printed board circuit includes a microprocessor, a memory component, an I/O system, and a system bus for executing and processing a plurality of algorithms for controlling the taper lever height in response to changes in adjustment settings to the digital taper lever.

5. The electronic hair clipper of claim 1, wherein the touch sensor includes an electronic touchscreen panel.

6. The electronic hair clipper of claim 5, wherein the electronic touchscreen panel is configured to display graphical indicators which represent a taper lever height setting of the pair of clipper blades.

7. The electronic hair clipper of claim 6, wherein the graphical indicators include bars, dots, lines, symbols, or alpha-numeric characters.

8. The electronic hair clipper of claim 6, wherein the haptic feedback component includes a vibrating element using haptic technology that provides the user a tactile feedback response by introducing forces, vibrations, pulses, or motions in response to changes to the taper lever height setting on the touch sensor.

9. The electronic hair clipper of claim 1, wherein a first digital taper lever is disposed on a right side of the electronic hair clipper and a second digital taper lever is disposed on a left side of the electronic hair clipper.

10. The electronic hair clipper of claim 1, wherein a trigger sensor is disposed along a portion of the housing for activating the digital taper lever when a hand of the user is detected by the trigger sensor.

11. A method of cutting hair with an electronic hair clipper, wherein the electronic hair clipper includes a housing having a handle portion; a pair of clipper blades disposed on a top portion of the housing; and a digital taper lever disposed along an upper side portion of the housing near the pair of clipper blades for electronically controlling a taper lever height of the pair of clipper blades, wherein the digital taper lever includes a touch sensor having an arc shape pattern that has an inward curve along a portion of the arc shape pattern, and wherein the inward curve of the arc shape pattern is oriented in an upward direction facing the pair of clipper blades, the method comprising:
gripping the handle portion of the housing by a hand of a user;
applying a thumb of the user over the digital taper lever;
pressing the thumb firmly against the touch sensor making contact thereon; and
swiping the thumb along the arc shape pattern of the touch sensor to increase or decrease a taper lever height setting of the digital taper lever.

12. The method of claim 11, further comprising internal components disposed inside an interior of the housing, wherein the internal components includes an actuator assembly disposed underneath the pair of clipper blades, a haptic feedback component disposed alongside the digital taper lever, a printed board circuit electrically coupled to the actuator assembly and the haptic feedback component via wiring members, and a battery coupled to printed board circuit via the wiring members for providing power to the electronic hair clipper.

13. The method of claim 12, further comprising a main power button and an LED/LCD screen disposed along an external portion of the housing and electrically coupled to the printed board circuit via the wiring members.

14. The method of claim 12, wherein the printed board circuit includes a microprocessor, a memory component, an I/O system, and a system bus for executing and processing a plurality of algorithms for controlling the taper lever height in response to changes in adjustment settings to the digital taper lever.

15. The method claim 11, wherein the touch sensor includes an electronic touchscreen panel.

16. The method of claim 15, wherein the electronic touchscreen panel is configured to display graphical indicators which represent a taper lever height setting of the pair of clipper blades.

17. The method of claim 16, wherein the graphical indicators include bars, dots, lines, symbols, or alpha-numeric characters.

18. The method of claim 16, wherein the haptic feedback component includes a vibrating element using haptic technology that provides the user a tactile feedback response by introducing forces, vibrations, pulses, or motions in response to changes to the taper lever height setting on the touch sensor.

19. The method of claim 11, wherein a first digital taper lever is disposed on a right side of the electronic hair clipper and a second digital taper lever is disposed on a left side of the electronic hair clipper.

20. The method of claim 11, wherein a trigger sensor is disposed along a portion of the housing for activating the digital taper lever when a hand of the user is detected by the trigger sensor.
